(19) United States
(12) Patent Application Publication
(10) Pub. No.: US 2021/0110790 A1
(43) Pub. Date: Apr. 15, 2021

(54) INFORMATION PROCESSING DEVICE, INFORMATION PROCESSING METHOD, AND RECORDING MEDIUM

(71) Applicant: SONY CORPORATION, TOKYO (JP)

(72) Inventors: OSAMU SHIGETA, TOKYO (JP); TAKUYA IKEDA, TOKYO (JP); FUMIHIKO IIDA, TOKYO (JP); RYUICHI SUZUKI, TOKYO (JP); KENTARO IDA, TOKYO (JP)

(21) Appl. No.: 17/055,352

(22) PCT Filed: Feb. 21, 2019
(86) PCT No.: PCT/JP2019/006586

§ 371 Date: Nov. 13, 2020

(30) Foreign Application Priority Data
May 16, 2018 (JP) 2018-094440

(51) Int. Cl. G09G 5/14; H04N 9/31

(52) U.S. Cl. CPC G09G 5/14; H04N 9/3194; H04N 9/3188; H04N 9/3185

(57) ABSTRACT

Provided are an information processing device, an information processing method, and a recording medium that enable display control to be performed more properly in response to an instruction for display from a user in a display system that a plurality of persons uses. The information processing device includes a control unit that determines, when an instruction for display from a user is detected, display control corresponding to the instruction for display from the user, in accordance with the position of the user and the current display condition having already been displayed to a different user.

### TECHNICAL FIELD

The present disclosure relates to an information processing device, an information processing method, and a recording medium.

### BACKGROUND ART

In recent years, regarding a projector that projects a picture on a wall or a screen, a drive-type projector equipped with a pan/tilt drive mechanism has been developed. Driving such a projector enables projection of a picture at any place.

In addition to driving a projector itself, there is a proposed technology in which a mirror having a pan/tilt drive mechanism is disposed on the front of a projector, and changing the direction of reflection of the mirror causes projection of a picture at any place.

Moreover, with a combination of a pointing device, such as a laser pointer, and a camera that observes a pointed position, a projector can be driven such that a picture is displayed at a place pointed by a user. For example, Patent Document 1 below discloses a system in which picture output is switched, at an area where the projective region of a stationary projector and the projective region of a drive-type projector overlap, from one projector to the other projector.

### CITATION LIST

### Patent Document

Patent Document 1: WO 2017/154609

### SUMMARY OF THE INVENTION

### Problems to be Solved by the Invention

However, in a case where a plurality of persons uses such a drive-type projector, even a user is using the drive-type projector, a later operation from a different user may cause a display place or a display content to be switched to another one.

Thus, an object of the present disclosure is to propose an information processing device, an information processing method, and a recording medium that enable display control to be performed more properly in response to an instruction for display from a user in a display system that a plurality of persons uses.

### Solutions to Problems

According to the present disclosure, proposed is an information processing device including: a control unit configured to determine, when an instruction for display from a user is detected, display control corresponding to the instruction for display from the user, in accordance with a position of the user and a current display condition having already been given to a different user.

According to the present disclosure, proposed is an information processing method to be performed by a processor, the information processing method including: determining, when an instruction for display from a user is detected, display control corresponding to the instruction for display from the user, in accordance with a position of the user and a current display condition having already been given to a different user.

According to the present disclosure, proposed is a recording medium storing a program for causing a computer to function as a control unit that determines, when an instruction for display from a user is detected, display control corresponding to the instruction for display from the user, in accordance with a position of the user and a current display condition having already been given to a different user.

### Effects of the Invention

As described above, according to the present disclosure, display control can be performed more properly in response to an instruction for display from a user in a display system that a plurality of persons uses.

Note that the effect is not necessarily limitative and thus any effect described in the present specification or other effects that can be grasped from the present specification may be provided in addition to the above-described effect or instead of the effect.

### BRIEF DESCRIPTION OF DRAWINGS

FIG. 1 is an explanatory view of an outline of an information processing system according to an embodiment of the present disclosure.

FIG. 2 is an explanatory view of a problem that may occur in a case where a plurality of persons uses a display system.

FIG. 3 is a block diagram of an exemplary functional configuration of each device in the information processing system according to the embodiment of the present disclosure.

FIG. 4 is a flowchart of an exemplary flow of calculation processing of a projective position according to a first embodiment.

FIG. 5 is an explanatory view of a case where, with calculation of viewing/listening regions, made is a determination of whether or not an image can be projected at a position visible to both users, according to the first embodiment.

FIG. 6 is an explanatory view of a case where, with calculation of viewing/listening regions with view frustums, made is a determination of whether or not an image can be projected at a position visible to both users, according to the first embodiment.

FIG. 7 is an explanatory view of calculation of a projective position based on the positions and orientations of a plurality of users in a room, according to the first embodiment.

FIG. 8 is an explanatory view of an outline of split display according to a second embodiment.

FIG. 9 is a flowchart of an exemplary flow of display control processing enabling the split display according to the second embodiment.

FIG. 10 is an explanatory view of change in projective position on a table, according to a modification of the second embodiment.

FIG. 11 is an explanatory view of split display on a table, according to a modification of the second embodiment.

FIG. 12 is an explanatory view of exemplary split display with a plurality of drive mirrors, according to a modification of the second embodiment.

FIG. 13 is a flowchart of an exemplary flow of cancellation operation processing according to a third embodiment.

FIG. 14 is a view of an exemplary cancellation notification screen according to the third embodiment.

FIG. 15 is an explanatory sequence diagram of feedback at time of predecessor priority according to a fourth embodiment.

FIG. 16 is an explanatory sequence diagram of feedback at the time of successor priority according to the fourth embodiment.

FIG. 17 is an explanatory sequence diagram of feedback at the time of sharing priority according to the fourth embodiment.

FIG. 18 is a flowchart of an exemplary flow of drive control processing according to a fifth embodiment.

FIG. 19 is an explanatory view of use of a projector that projects pictures simultaneously at a plurality of places by a time-division technique with drive mirrors, according to an application of the present embodiment.

### MODE FOR CARRYING OUT THE INVENTION

Preferred embodiments of the present disclosure will be described in detail below with reference to the accompanying drawings. Note that, in the present specification and the drawings, components having substantially the same functional configurations are denoted with the same reference signs, and thus the duplicate descriptions thereof will be omitted.

Moreover, the descriptions will be given in the following order.

1. Outline of Information Processing System according to Embodiment of Present Disclosure

2. Configurations

2-1. Exemplary Configuration of Information Processing Device 100

2-2. Exemplary Configuration of Drive Projector 300

3. Embodiments

3-1. First Embodiment (Calculation of Projective Position)

3-2. Second Embodiment (Display of Split Image)

(Modification 1: Control of Returning Screen)

(Modification 2: Display Change on Table)

(Modification 3: Split Projection with Plurality of Drive Mirrors)

3-3. Third Embodiment (Cancellation Operation)

3-4. Fourth Embodiment (Feedback)

3-5. Fifth Embodiment (Priority Rule Setting)

4. Applications

5. Summary

### 1. OUTLINE OF INFORMATION PROCESSING SYSTEM ACCORDING TO EMBODIMENT OF PRESENT DISCLOSURE

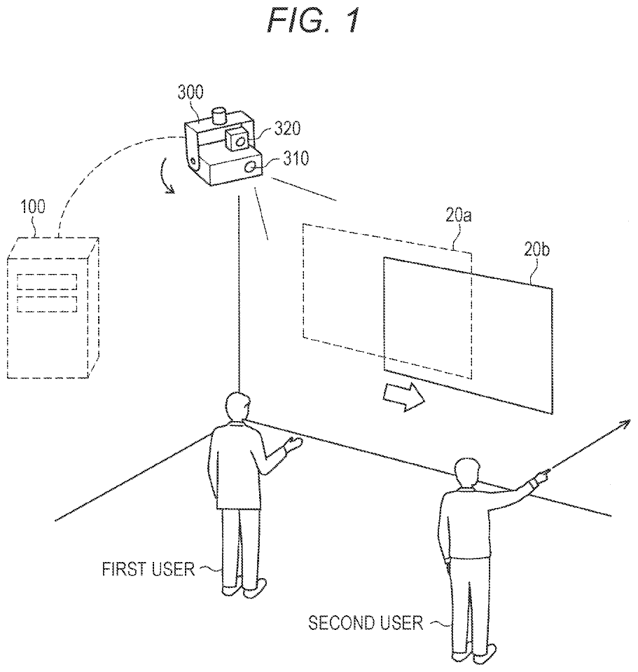

FIG. 1 is an explanatory view of an outline of an information processing system according to an embodiment of the present disclosure. As illustrated in FIG. 1, the information processing system 1 according to the present embodiment includes: a drive projector 300 that is installed in a space, such as a meeting room or an individual room, and projects a picture on a wall, a table, a floor, a ceiling, furniture, or the like; and an information processing device 100 that controls the drive of the drive projector 300 and picture projection.

The drive projector 300 is equipped with a pan/tilt drive mechanism, and is capable of projecting a picture at any place in the space. Moreover, the drive projector 300 is not limited to a drive mechanism that makes a change in orientation, like the pan/tilt drive mechanism, and thus may further have a mechanism capable of moving the drive projector 300 itself, for example, left, right, upward, downward, and the like. For example, a user can designate the projective position of the drive projector 300 by voice (e.g., voice recognition, such as “Display here”, and the orientation of the face of the user), gesture (e.g., pointing), or use of an input device, such as a pointing device. Moreover, the information processing device 100 is capable of recognizing the position or posture of a user, to automatically determine a projective position. The drive projector 300 includes a projector 310 that projects an image and a sensor 320 that senses, for example, the position, gesture, or uttered voice of a user.

(Background)

Here, use of a drivable projector enables projection of pictures at various places in the space. However, at the time of use of such a projector between a plurality of persons, the following problem occurs.

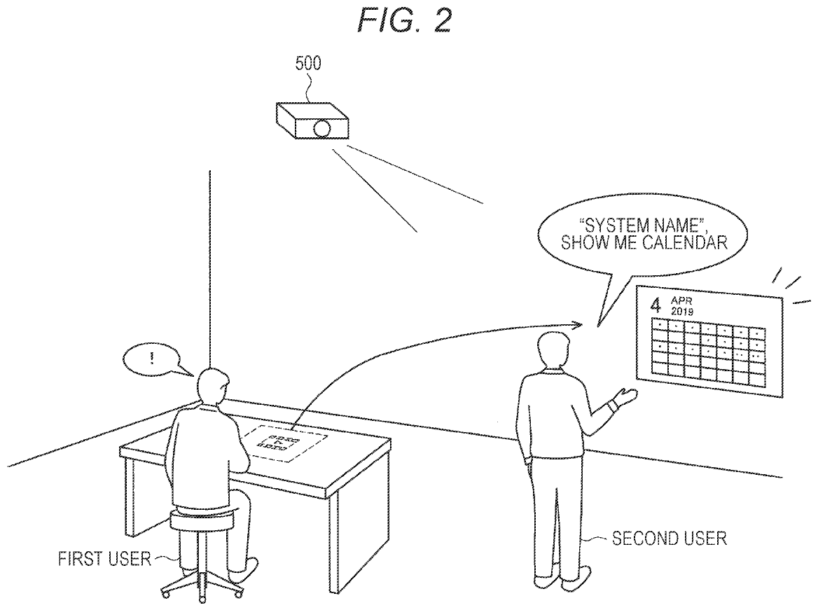

For example, as illustrated in FIG. 2, if a second user issues an instruction for a call for a new screen while a first user is viewing/listening to a picture with a drive-type projector 500, the projector 500 switches a display content to another one or changes a display position in accordance with the instruction from the second user. Thus, there occurs a problem that the picture that the first user is currently viewing/listening to suddenly vanishes.

Therefore, in consideration of such a situation, proposed is a mechanism in which the information processing system according to the present disclosure performs display control more properly in response to an instruction for display from a user in a display system that a plurality of persons uses.

For example, when the second user issues an instruction for display (e.g., a case where the utterance “Show here too” is given) while the first user is doing viewing/listening, as illustrated in FIG. 1, for example, the information processing system according to the present embodiment moves an image 20a presented to the first user to a position favorable to both users, in accordance with the positions of both users (refer to an image 20b). Even in a case where the display position deviates slightly from the position instructed by the second user, the information processing device 100 prioritizes displaying in the visibilities of both users, resulting in achievement of display control favorable to both users. In the present specification, an instruction for display is issued by an uttered voice, a gesture, or use of an input device, such as a controller, and includes, for example, information regarding a display position. On the system side, displaying can be performed at a position visible to a user in accordance with the user position, in addition to explicit designation of a display position from the user (e.g., designation with pointing, the line of sight, or a pointing device). Thus, the information regarding a display position includes information regarding user position.

Moreover, in a case where a change is made not only in a display position but also in a display content (a case where a call for a new screen is made by the second user), the information processing system according to the present embodiment may split-display the image 20b, for example.

As above, according to the present embodiment, even in a case where a later operation is performed for an instruction for display, display control can be performed more properly in accordance with the condition of a plurality of users.

The information processing system according to the embodiment of the present disclosure has been described above. Next, the specific configuration of each device included in the information processing system according to the present embodiment, will be described with reference to the drawings.

### 2. EXEMPLARY CONFIGURATIONS

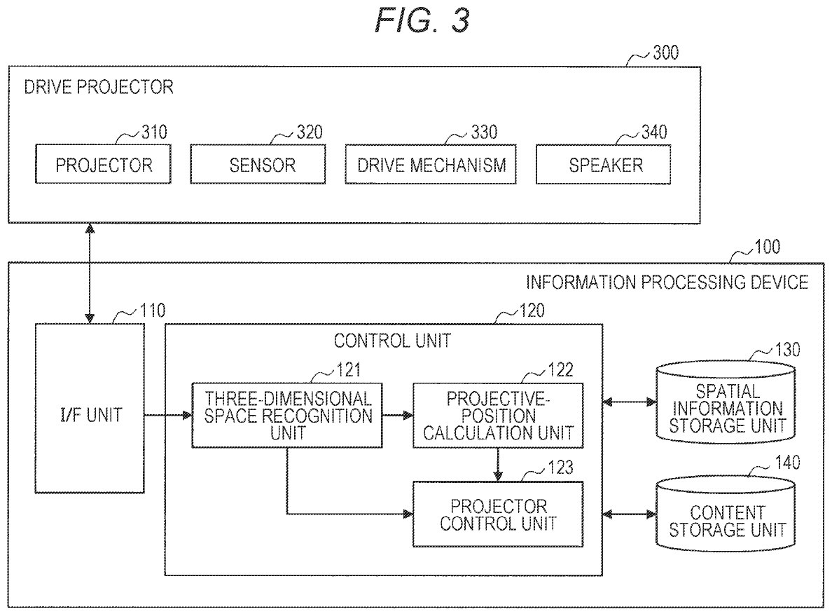

FIG. 3 is a block diagram of an exemplary functional configuration of each device in the information processing system according to the embodiment of the present disclosure. As illustrated in FIG. 3, the information processing system according to the present embodiment includes the information processing device 100 and the drive projector 300.

### 2-1. Exemplary Configuration of Information Processing Device 100

The information processing device 100 includes: an interface (I/F) unit 110; a control unit 120 that functions as a three-dimensional space recognition unit 121, a projective-position calculation unit 122, and a projector control unit 123; a spatial information storage unit 130, and a content storage unit 140.

(I/F Unit 110)

The I/F unit 110 is a connection device that connects the information processing device 100 and other equipment. The I/F unit 110 is achieved with, for example, a universal serial bus (USB) connector, and performs input and output of information between each component in the drive projector 300 and the I/F unit 110. Moreover, for example, the I/F unit 110 connects with the drive projector 300 through a wireless/wired local area network (LAN), Digital Living Network Alliance (DLNA) (registered trademark), Wi-Fi (registered trademark), Bluetooth (registered trademark), other dedicated cables, or the like. Moreover, the I/F unit 110 may connect with other equipment through the Internet or a home network.

For example, the I/F unit 110 receives, from the drive projector 300, sensing data of various types of sensors included in a sensor 320 in the drive projector 300. Moreover, in accordance with the control of the projector control unit 123, the I/F unit 110 transmits a drive control signal and an output signal, such as a picture and a voice, to the drive projector 300.

(Control Unit 120) The control unit 120 functions as an arithmetic processing device and a control device, and controls the overall operation in the information processing device 100, in accordance with various types of programs. For example, the control unit 120 is achieved with an electronic circuit, such as a central processing unit (CPU) or a microprocessor. Moreover, the control unit 120 may include a read only memory (ROM) that stores, for example, a program and arithmetic parameters for use, and a random access memory (RAM) that temporarily stores, for example, parameters that vary appropriately.

Moreover, as illustrated in FIG. 3, the control unit 120 functions as the three-dimensional space recognition unit 121, the projective-position calculation unit 122, and the projector control unit 123.

Three-Dimensional Space Recognition Unit 121

On the basis of sensing data detected by the various types of sensors provided in the sensor 320 (e.g., a captured image by a camera or a bird's eye view camera (visible light image or infrared image), depth information by a depth sensor, distance information by a ranging sensor, temperature information by a thermosensor, and voice information by a microphone), the three-dimensional space recognition unit 121 recognizes, for example, the three-dimensional shape of a projective-environment space (e.g., a room in which the drive projector 300 is installed), the three-dimensional shape or three-dimensional position of a real object present in the projective-environment space, a projectable region (e.g., a planar region having a predetermined extent), or the three-dimensional position, posture, gesture, uttered voice of a user, or the like.

According to the present embodiment, for example, it is assumed that the three-dimensional shape of the projective-environment space is recognized, on the basis of sensing data by the depth sensor. Moreover, the three-dimensional space recognition unit 121 recognizes the three-dimensional shape of the projective-environment space and additionally generates a projective-environment space map. Moreover, the three-dimensional space recognition unit 121 may measure a three-dimensional shape with the ranging sensor or by stereo matching with a plurality of cameras. Moreover, the three-dimensional space recognition unit 121 is capable of recognizing illuminance in the projective-environment space, such as light from outside or indoor lighting.

As above, various types of spatial information recognized by the three-dimensional space recognition unit 121 are stored in the spatial information storage unit 130.

Projective-Position Calculation Unit 122

On the basis of a recognition result from the three-dimensional space recognition unit 121 or spatial information accumulated in the spatial information storage unit 130, the projective-position calculation unit 122 appropriately calculates a projective position and outputs the calculated projective position to the projector control unit 123.

For example, the projective-position calculation unit 122 calculates a projective position, in accordance with an instruction for projection (instruction for display) from a user. It is assumed that an instruction for projection from a user is issued, for example, by voice, gesture, or use of an input device. In a case where a user issues an instruction for projection, the projective-position calculation unit 122 calculates a projective position in accordance with, for example, the position of the user.

Specifically, for example, the projective-position calculation unit 122 calculates a projective position, in accordance with a voice recognition result of voice data collected by the microphone provided in the drive projector 300 or by a microphone provided in the room. For example, when a user requests a change in a display position or calls for a new screen using phrases such as “Display here”, “Show me a calendar”, “[system name]!”, or utters a predetermined keyword such as an agent name, the projective-position calculation unit 122 calculates a proper projective position (three-dimensional-position coordinates), in accordance with the position, posture (including the orientation of the head or the face), line of sight, or gesture (e.g., pointing, movement of a hand or an arm, or movement of the head) of the user. Examples of a proper projective position that are assumed, include the position at which the direction in which a user points a user's finger and the projectable region (e.g., a wall) are orthogonal, the projectable region near the user (e.g., a table), the position at which the direction of line-of-sight of the user and the projectable region are orthogonal, and the like.

Moreover, the projective-position calculation unit 122 may detect, as a projective position, the bright point (bright point on a wall or a table) of light emitted from a light-emitting unit, such as an IR LED, provided at a pointing device that a user operates, from a captured image acquired by a camera capable of observing, for example, infrared light. The camera may be a bird's eye view camera capable of observing infrared light with a wide field of view.

Note that a projective position is not necessarily designated from a position apart from the projectable region, and thus can be designated, for example, by a touch operation to the projectable region. The projective-position calculation unit 122 analyzes information acquired from, for example, a depth camera, so that a touch operation to the projectable region is detected.

Moreover, the projective-position calculation unit 122 is not limited to an operation input from a pointing device provided with an IR LED, and is capable of recognizing designation of a projective position input from an information processing terminal, such as a smartphone, for example. For example, a user may operate a GUI including up/down/left/right keys displayed on the screen of a smartphone, to designate a projective position, or may operate an omnidirectional image of the projective-environment space displayed on the screen of the smartphone, to designate a projective position.

As described above, basically, the projective-position calculation unit 122 calculates a projective position, in accordance with an instruction for projection from a user. In a case where the second user issues an instruction for projection while the first user is currently using the drive projector 300 (namely, while the drive projector 300 is currently presenting information to the first user), the projective-position calculation unit 122 appropriately calculates a proper projective position, in accordance with the conditions of both users, such as the respective positions of both users. For example, in a case where the first and second users share visibility (namely, in a case where a position visible to both users is present), the projective-position calculation unit 122 calculates the visible position as a projective position. Control processing in a case where a different user issues an instruction for projection later, will be described in detail in each embodiment to be described later.

Moreover, in the information processing system according to the present embodiment, even in a case where no explicit instruction for projection is issued from a user, it is assumed that the system automatically (spontaneously) presents information, such as an alarm, an incoming message, recommended information, display of a calendar, or display of an agent image. In this case, the projective-position calculation unit 122 calculates a proper projective position from a recognition result of the projective-environment space (e.g., a position that catches family's attention easily, such as a position near the television) or in accordance with, for example, the position or posture of a user (e.g., a position near the user, a position in the direction of line-of-sight of the user, or other positions).

Projector Control Unit 123

The projector control unit 123 controls the drive projector 300 such that a predetermined image is projected at the projective position calculated by the projective-position calculation unit 122. Specifically, the projector control unit 123 performs drive control of the drive projector 300 (e.g., control in drive angle), generation of an image to be projected from the drive projector 300, and generation of a voice signal to be output from a speaker 340.

For example, the projector control unit 123 generates a drive control signal for an instruction for drive to position, and transmits the generated drive control signal to the drive projector 300 through the I/F unit 110. Specifically, the projector control unit 123 generates a drive control signal for an instruction for drive to position such that an image can be projected at the projective position calculated by the projective-position calculation unit 122.

Moreover, the projector control unit 123 generates an image to be projected from the projector 310 of the drive projector 300 and a voice signal to be output from the speaker 340, and transmits the image and the voice signal to the drive projector 300 through the I/F unit 110. Examples of an image to be projected and a voice that are assumed, include an agent image, an agent voice, and various types of content responsive to requests from a user. Examples of the various types of content include images (moving image and still image), music, voice, text, and the like. Such various types of content may be acquired from the content storage unit 160 or may be acquired from a network through the I/F unit 110. Moreover, such a content may include various types of display screens that are generated by the information processing device 100 or an application that operates on the network.

As described above, basically, the projector control unit 123 controls output of various types of content from the drive projector 300, in accordance with an instruction for projection from a user. Here, for example, in a case where the second user issues, while the first user is currently viewing/listening to a content, a later instruction for projection of a different content (namely, an instruction for display of a new screen), for example, the projector control unit 123 splits the screen to display both pieces of the content, so that display control can be performed more properly to a plurality of users. Here, the “new screen” is a screen different from the screen having already been displayed. Assumed are various screens, such as a home menu, an arbitrary application screen, and a screen for calling for an agent. Split display of a screen will be described in detail in embodiments to be described later.

The configuration of the information processing device 100 according to the present embodiment has been specifically described above. Note that the information processing device 100 is not limited in configuration to the example illustrated in FIG. 3. Thus, for example, at least part of the configuration of the information processing device 100 may be achieved with an external device, such as a server.

Moreover, the information processing device 100 may be achieved, for example, with a smart home terminal, a PC, a smartphone, a tablet terminal, a home server, an edge server, an intermediate server, or a cloud server.

### 2-2. Exemplary Configuration of Drive Projector 300

Next, an exemplary configuration of the drive projector 300 according to the present embodiment will be described.

The drive projector 300 is equipped with the projector 310 and the speaker 340 as output units. Furthermore, the drive projector 300 may be equipped with an ultrasonic speaker having high directivity. The ultrasonic speaker may be installed coaxially in the direction of projection of the projector 310.

Moreover, the drive projector 300 is provided with the sensor 320. The drive projector 300 outputs information sensed by each sensor in the sensor 320, to the information processing device 100. The sensor 320 may include, for example, a camera, a bird's eye view camera, a depth sensor, a ranging sensor, a thermosensor, a microphone, and the like. According to the present embodiment, the bird's eye view camera is assumed as a camera having a wide viewing angle, and grasps the position or orientation of a user in the space. Then, furthermore, use of a camera that gazes at a region, narrower in viewing angle than the bird's eye view camera, enables the condition of the user to be grasped more accurately. The camera and the bird's eye view camera each may have a mode in which zooming is performed and a mode in which a change is made in aperture.

Moreover, the depth sensor, the ranging sensor, or the thermosensor is assumed to be used, for example, in three-dimensional space recognition of projective environment that the three-dimensional space recognition unit 121 performs.

Moreover, the drive projector 300 includes a drive mechanism 330, and is capable of changing the orientation of the projector 310 and the orientation of the sensor 320 such that projection can be performed in any direction and sensing can be performed in any direction. For example, the drive projector 300 performs drive control with the drive mechanism 330 such that a picture is projected at a predetermined position received from the information processing device 100. Note that, according to the present embodiment, a pan/tilt biaxial drive mechanism is exemplarily assumed. However, the present embodiment is not limited to a drive mechanism that makes a change in orientation, and thus a mechanism enabling, for example, left, right, upward, and downward movements may be further provided. Moreover, according to the present embodiment, assumed is a mechanism of driving the drive projector 300 itself (or at least the projector 310 and the sensor 320). However, provided may be a device including mirrors having respective drive mechanisms (drive mirrors) installed ahead of the projector 310 and the sensor 320, in which the orientations of the mirrors are changed to change the direction of projection and the direction of sensing.

Moreover, according to the present embodiment, as illustrated in FIG. 1, it is assumed that the sensor 320 is mounted coaxially on the projector 310 and additionally the sensor 320 is driven by the drive mechanism 330, simultaneously with the projector 310. However, the present embodiment is not limited to this, and thus the sensor 320 and the projector 310 may be disposed at different positions. In this case, the positional relationship between the sensor 320 and the projector 310 is known.

The configuration of the drive projector 300 according to the present embodiment has been specifically described above. Note that the drive projector 300 according to the present embodiment is not limited in configuration to the example illustrated in FIG. 3. For example, the sensor 320 and the speaker 340 may be separated from the drive projector 300.

### 3. EMBODIMENTS

Next, the information processing system according to the present embodiment will be specifically described with a plurality of embodiments.

### 3-1. First Embodiment (Calculation of Projective Position)

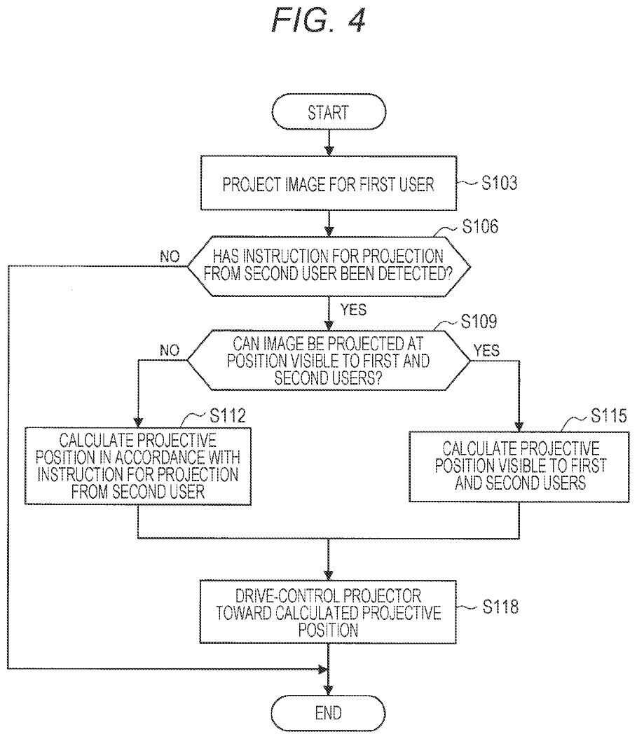

First, a first embodiment will be specifically described with reference to FIGS. 4 to 7, in which in a case where the second user issues an instruction for projection while the first user is currently using the drive projector 300, a proper projective position is calculated in accordance with, for example, the positions of both users.

FIG. 4 is a flowchart of an exemplary flow of calculation processing of a projective position according to the present embodiment. As illustrated in FIG. 4, first, while the drive projector 300 is projecting an image for the first user (step S103), in a case where an instruction for projection is detected from the second user (step S106/Yes), the projective-position calculation unit 122 of the information processing device 100 determines whether or not an image can be projected at a position visible to both of the first and second users (step S109).

Whether or not an image can be projected at a position visible to both of the first and second users is determined in accordance with, for example, the current positions, orientations of the faces, directions of line-of-sight, or the like of both users, based on sensing data of the sensor 320. In a case where a projective position is designated by an input device, such as a pointing device, a determination is made on the basis of the designated projective position. For example, in a case where an image can be projected in a range including all the intersections between the respective directions in which the users face and the projectable region (gaze points on the projectable region) (or the position for the destination of projection designated first by the first user with the input device and the position for the destination of projection designated later by the second user with the input device), the projective-position calculation unit 122 determines that an image can be projected at a position visible to both users. Note that, because a slight change in the orientation of the face or body of a user causes the gaze point to be changed easily, in a case where respective predetermined ranges in which the gaze points of both users are at the centers overlap, it may be determined that an image can be projected at a position visible to both users.

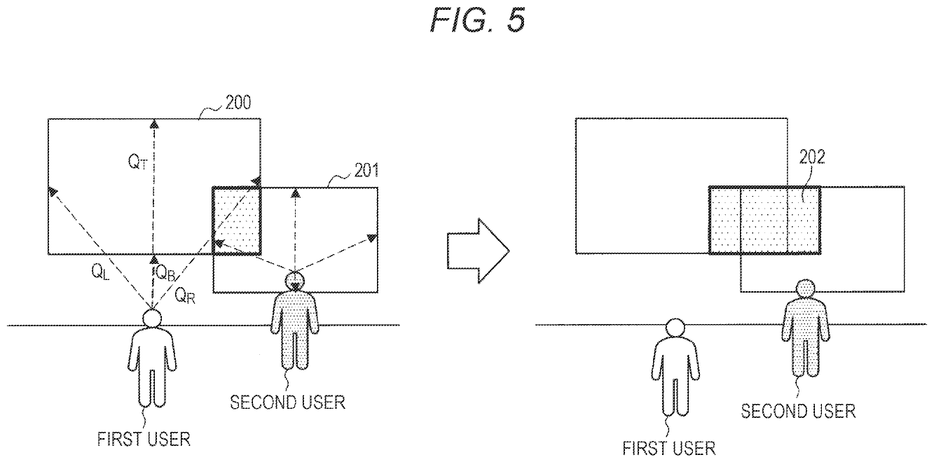

Moreover, the projective-position calculation unit 122 may calculate the respective viewing/listening regions of a plurality of users (namely, the respective ranges of visibility) and may make a determination on the basis of the degree of overlap therebetween. FIG. 5 is an explanatory view of a case where, with calculation of viewing/listening regions, made is a determination of whether or not an image can be projected at a position visible to both users. As illustrated on the left of FIG. 5, for example, viewing/listening regions 200 and 201 are calculated on the basis of the angles of visibility of users to the projectable region (right-end angle (R), left-end angle (L), upper-end angle (T), and lower-end angle (B)). In a case where an overlap is present, it is determined that an image can be projected at a position visible to both users. In this case, as illustrated on the right of FIG. 5, for example, a range including the region of the overlap may be determined as a projective position 202.

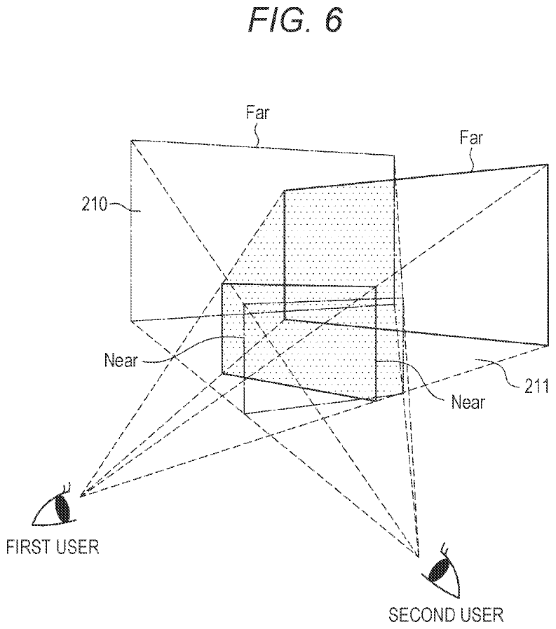

Moreover, in calculation of viewing/listening regions, the projective-position calculation unit 122 may calculate three-dimensional view frustums and may make a determination on the basis of determination of overlap therebetween. Considering that the field of view of a human is actually irregularly conical in shape, for example, as illustrated in FIG. 6, three-dimensional shapes (view frustums) each present between a near-clip plane (Near) and a far-clip plane (Far) may be calculated, and then whether or not an image can be projected at a position visible to both users may be determined on the basis of determination of overlap therebetween.

As above, various techniques are provided as methods of calculating the range of visibility. In a case where present is a region in which at least parts of the ranges of visibility of a plurality of users overlap, the projective-position calculation unit 122 may determine that the plurality of users can share visibility and then may determine a range including the overlap region as a projective position.

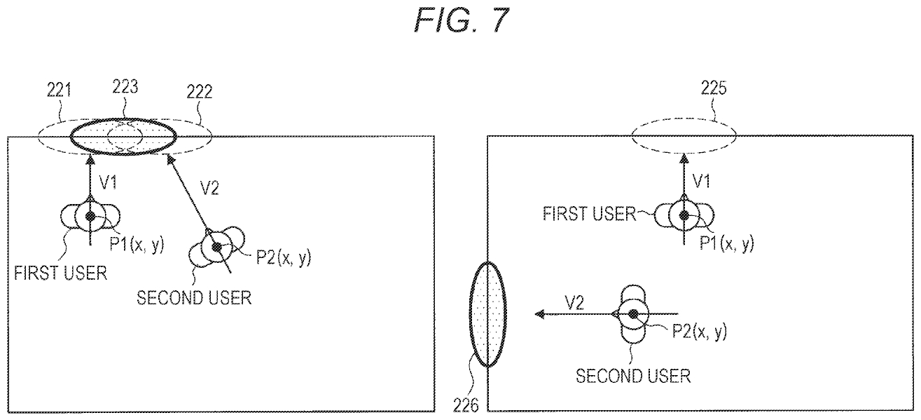

Moreover, the projective-position calculation unit 122 is not strictly limited to overlap between ranges of visibility, and thus can determine whether or not sharing is possible in visibility, on the basis of the positions of a plurality of users or the positions and orientations of the plurality of users in the space. FIG. 7 is an explanatory view of calculation of a projective position based on the positions and orientations of a plurality of users in the room.

As illustrated on the left of FIG. 7, for example, on the basis of the position P1 and orientation V1 (face, head, or body) of the first user and the position P2 and orientation V2 of the second user, in a case where regions 221 and 222 in which the orientations V intersect with the projectable region (e.g., a wall) overlap, it is determined that an image can be projected at a position visible to both users. In this case, a range 223 including the overlap region is determined as a projective position. Note that the sizes of the regions 221 and 222 may be a predetermined size set in advance. Meanwhile, in the example illustrated on the right of FIG. 7, no overlap is present between regions 225 and 226, and thus it is determined that an image cannot be projected at a position visible to both users. In this case, as described later, the projective-position calculation unit 122 prioritizes the second user having issued the later instruction for projection and determines a region 226 as a projective position.

Moreover, for example, in a case where the position for the destination of projection designated first by the first user with the input device and the position for the destination of projection designated later by the second user with the input device are included on the same face in the projectable region or in a case where both of the positions for the destination of projection are at a predetermined distance or less, the projective-position calculation unit 122 may determine that projection is possible at a position visible to both users. Note that one of the users may designate a position for the destination of projection with the input device and the other may designate a position for the destination of projection by voice or gesture.

Next, in a case where it is determined that an image cannot be projected at a position visible to both users (step S109/No), the projective-position calculation unit 122 prioritizes the second user having issued the later instruction for projection and calculates a projective position in accordance with the instruction for projection from the second user (step S112). That is the projective-position calculation unit 122 calculates a proper projective position, in accordance with the instruction for projection from the second user, without consideration of the condition of the first user.

Meanwhile, in a case where it is determined that an image can be projected at a position visible to both users (step S109/Yes), the projective-position calculation unit 122 calculates a projective position visible to both user (step S115). For example, as described above, a range including the overlap region between the respective ranges of visibility of both users may be determined as a projective position. Alternatively, a range having a center (e.g., intermediate position) between the respective gaze points of both users (or the current projective position and the position for the destination of projection designated with the input device or the like) may be determined as a projective position.

Next, the projector control unit 123 of the information processing device 100 drive-controls the drive projector 300 toward the calculated projective position (step S118). This arrangement causes an image to be projected at the calculated projective position (namely, the projective position of the image is changed).

Calculation of a projective position in a case where a plurality of users uses the drive projector 300, has been described above. Note that, in the operation processing illustrated in FIG. 4, in a case where a particular user wants to display an image at a particular position, there may be a problem that the image is displayed at the intermediate position between a plurality of users even though an instruction for projection is repeatedly issued. In consideration of such a case, for example, in a case where the same position is designated twice, the projective-position calculation unit 122 of the information processing device 100 may determine the second designated position as a projective position. Alternatively, for example, use of a particular gesture or a first keyword (magic word) may enable forcible designation of a projective position.

### 3-2. Second Embodiment

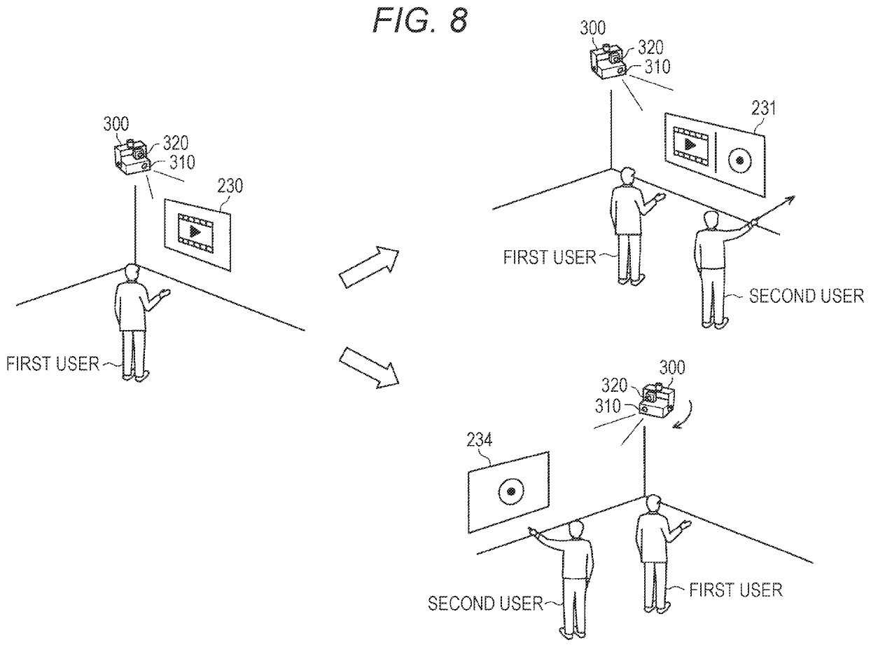

Next, a second embodiment will be described with reference to FIGS. 8 to 11. According to the first embodiment, the case where the second user issues an instruction for movement in projective position, has been described. Herein, more proper display control in a case where an instruction for projection from the second user includes a change in a projective content (namely, a call for a new screen), will be described.

More specifically, for example, assumed is a case where the second user issues a later instruction for projection including a call for a new screen while the first user is viewing/listening to an image 230 with the drive projector 300, as illustrated on the left of FIG. 8. The instruction for projection including a call for a new screen is a call for a screen different from the image 230. For example, assumed is a call for an agent screen with an utterance of an agent name. Moreover, in a case where an input device, such as a pointing device, is used, an instruction for a call for a new screen or an instruction for a simple change in the position of the currently projected image may be issued by an operation to a button or switch provided at the input device or may be issued by input of a voice to a microphone provided at the input device. Alternatively, a different method with a gesture operation on a touch pad provided at the input device may be used for the above achievement.

In this case, if both users can share visibility, as illustrated on the upper right of FIG. 8, displaying, between both users, of a split image 231 including the image having been viewed/listened to by the first user and the new image called by the second user makes it possible to meet both users' requests.

Note that, if both users cannot share visibility, as illustrated on the lower right of FIG. 8, the second user having issued the later instruction for operation is prioritized, so that an image 234 displaying the new image called by the second user is displayed at the position designated by the second user.

As above, if both users can share visibility, the user having already been doing viewing/listening can continue viewing/listening with a split screen even in a case where the other user calls for a different screen later.

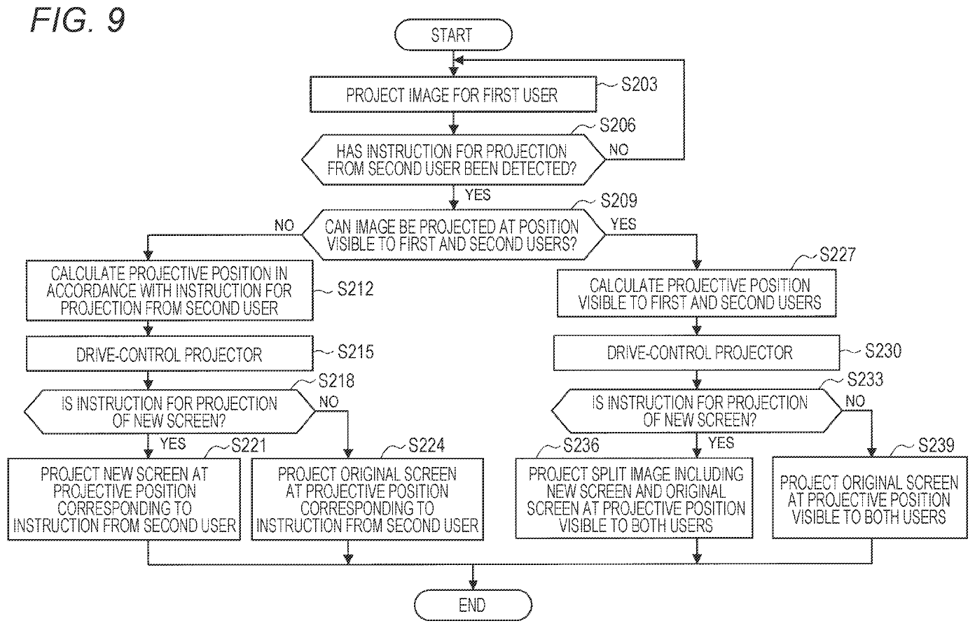

Operation processing according to the present embodiment will be described below with reference to FIG. 9. FIG. 9 is a flowchart of an exemplary flow of display control processing enabling split display according to the present embodiment.

As illustrated in FIG. 9, first, while the drive projector 300 is projecting an image for the first user (step S203), in a case where an instruction for projection is detected from the second user (step S206/Yes), the projective-position calculation unit 122 of the information processing device 100 determines whether or not an image can be projected at a position visible to both of the first and second users (step S209). The second embodiment is similar in determination technique to the first embodiment. The instruction for projection from the second user may be issued by an uttered voice, a gesture, or use of an input device, such as a pointing device, similarly to the first embodiment.

Next, in a case where it is determined that an image cannot be projected at a position visible to both users (step S209/No), the projective-position calculation unit 122 prioritizes the second user having issued the later instruction for projection and calculates a projective position in accordance with the instruction for projection from the second user (step S212).

Next, the projector control unit 123 generates a drive control signal for causing the drive projector 300 to be oriented toward the calculated projective position and transmits the drive control signal to the drive projector 300 through the I/F unit 110, to perform projector drive control (step S215).

Next, in a case where the instruction for projection from the second user is an instruction for projection of a new screen (step S218/Yes), the projector control unit 123 performs control such that the new screen is projected at the projective position corresponding to the instruction from the second user (step S221).

Meanwhile, in a case where the instruction for projection from the second user is not an instruction for projection of a new screen (step S218/No), the projector control unit 123 performs control such that the original screen (image having already been projected in step S203) is projected at the projective position corresponding to the instruction from the second user (step S224).

Note that the processing in steps S212 to S215 and the processing in steps S218 to S224 among the above-described steps are not necessarily performed in the order illustrated in FIG. 9, and thus may be performed in parallel or may be performed in the reverse order.

Moreover, in a case where it is determined that an image can be projected at a position visible to both users (step S209/Yes), the projective-position calculation unit 122 calculates a projective position visible to the first and second users (step S227). An exemplary specific calculation technique is similar to, for example, that according to the first embodiment.

Next, the projector control unit 123 generates a drive control signal for causing the drive projector 300 to be oriented toward the calculated projective position and transmits the drive control signal to the drive projector 300 through the I/F unit 110, to perform projector drive control (step S230).

Next, in a case where the instruction for projection from the second user is an instruction for projection of a new screen (step S233/Yes), the projector control unit 123 performs control such that a split image including the new screen and the original screen is projected at the projective position visible to both users (step S236).

Meanwhile, in a case where the instruction for projection from the second user is not an instruction for projection of a new screen (step S233/No), the projector control unit 123 performs control such that the original screen (image having already been projected in the above-described step S203) is projected at the projective position visible to both users (step S239).

Note that the processing in steps S227 to S230 and the processing in steps S233 to S239 among the above-described steps are not necessarily performed in the order illustrated in FIG. 9, and thus may be performed in parallel or may be performed in the reverse order.

(Modification 1: Control of Returning Screen)

According to the first and second embodiments described above, in a case where no position visible to both users is present, the second user having performed the later operation is prioritized, resulting in a change in projective position or a change in a projective content. Assumed is a case where the second user's use is a relatively short-term use, such as a schedule check, a weather forecast check, or a traffic information check. Meanwhile, if the second user's use finishes soon to the first user having already used the drive projector 300 and having viewed/listened to a relatively long content, such as a film or a drama, it is assumed that the first user wants to view/listen to the content again.

The information processing device 100 records, for example, when and what content someone is viewing/listening to or the viewing/listening history of a user having the screen moved due to an operation from a different user, enabling control of returning the screen appropriately.

For example, in a case where the second user's use finishes and then the first user issues an instruction for returning the projective position, the information processing device 100 performs control such that the screen of the content viewed by the first user just before is displayed at a designated position. Note that it is assumed that the first user wants to view the screen viewed by the second user. Thus, in a case where an instruction for display of the original screen is explicitly issued, the screen may be restored. For example, assumed is a clear instruction with a voice, such as “Display the screen displayed before” or an operation to a particular button on a pointing device.

Moreover, in a case where the second user has not viewed the screen for a certain time or has not interacted, the information processing device 100 can automatically return the screen to the first user due to timeout. Alternatively, in accordance with the detail of the content called by the second user or the detail of the instruction from the second user, the information processing device 100 may determine interrupt work that finishes in a certain time, to return the screen to the first user after the elapse of a predetermined time. Specifically, for a particular content, such as weather forecast or traffic information, interrupt work that finishes in a certain time may be determined. In a case where short-term use can be recognized from a voice, such as “Show the time a little” or “Show a little”, interrupt work that finishes in a certain time may be determined. Moreover, in a case where explicit finish processing is performed by the second user (e.g., a voice, such as “Thank you” or “That's okay”, a particular gesture, or an operation to a particular button), the information processing device 100 may return the screen to the first user.

(Modification 2: Display Change on Table)

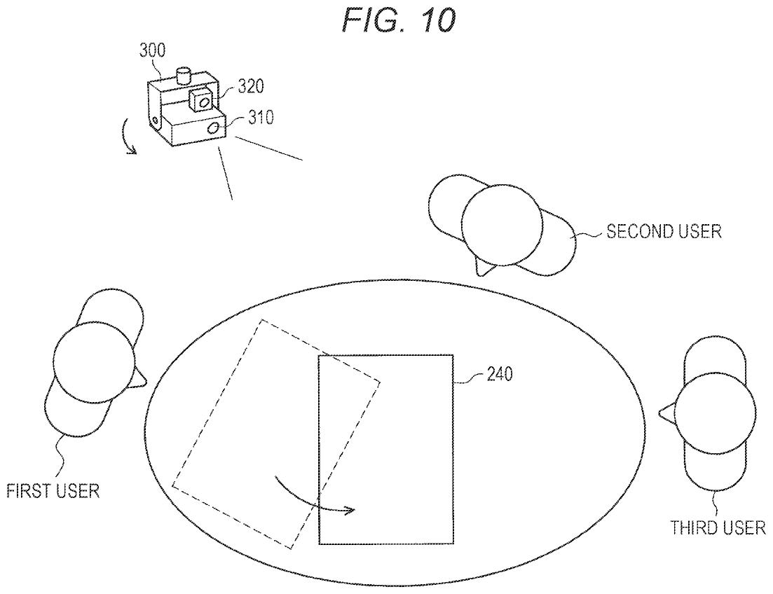

Regarding change in projective position in a case where a plurality of users can share visibility, the information processing device 100 is not limited to determination based on viewing angle, such as visibility, and thus may make a determination in accordance with the position of each user. For example, as illustrated in FIG. 10, in a case where the drive projector 300 projects an image 240 on the table, on the basis of the positions of a plurality of users around the table, a change may be made in projective position (e.g., to the center).

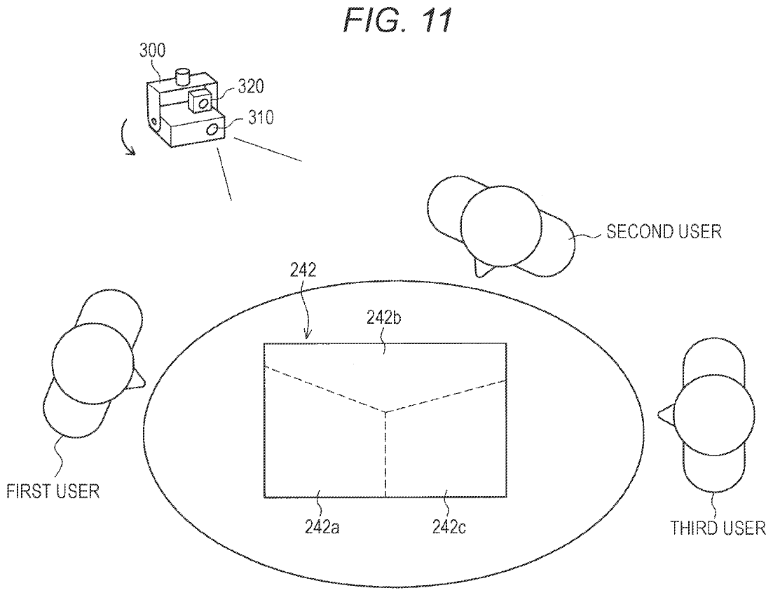

Moreover, split display is not limited to the side-by-side split display as illustrated in FIG. 8. For example, as illustrated in FIG. 11, in a case where the drive projector 300 projects an image 242 on the table, the image 242 may be split arbitrarily in accordance with the positions of a plurality of users around the table. Moreover, in accordance with the position of each user, the information processing device 100 may consider the top and bottom of an image or may consider positional relationship spatially.

(Modification 3: Split Projection with Plurality of Drive Mirrors)

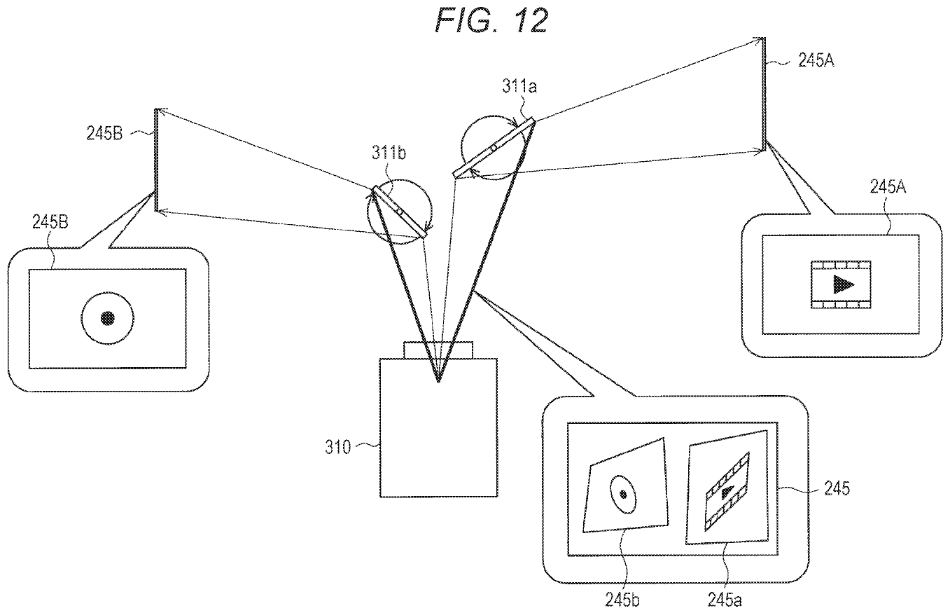

The drive projector 300 is not limited to pan/tilt drive. Installation of a mirror having pan/tilt drive (hereinafter, referred to as a drive mirror) ahead of the projector, enables any change in projective position. Moreover, with a plurality of drive mirrors, reflection of part of a projective image from the projector on each drive mirror enables presentation of respective images for a plurality of users. Description will be given below with reference to FIG. 12.

FIG. 12 is an explanatory view of exemplary split display with a plurality of drive mirrors according to the present modification. As illustrated in FIG. 12, mirror-reflection regions 245a and 245b of a projective image 245 projected from the projector 310 are reflected, respectively, on a plurality of drive mirrors 311a and 311b disposed ahead of the projector 310, so that different projective images 245A and 245B can be displayed at different places. Each of the mirror-reflection regions 245a and 245b included in the projective image 245 is trapezoid-corrected in accordance with reflection on the drive mirror and the planar shape of a projective place. Moreover, two drive mirrors are exemplarily used herein, but the present modification is not limited to this. Thus, three or more drive mirrors may be provided such that images are projected appropriately at any places. Moreover, adjustment of the number of drive mirrors and the arrangement of drive mirrors enables display of different projective images at three or more places.

### 3-3. Third Embodiment

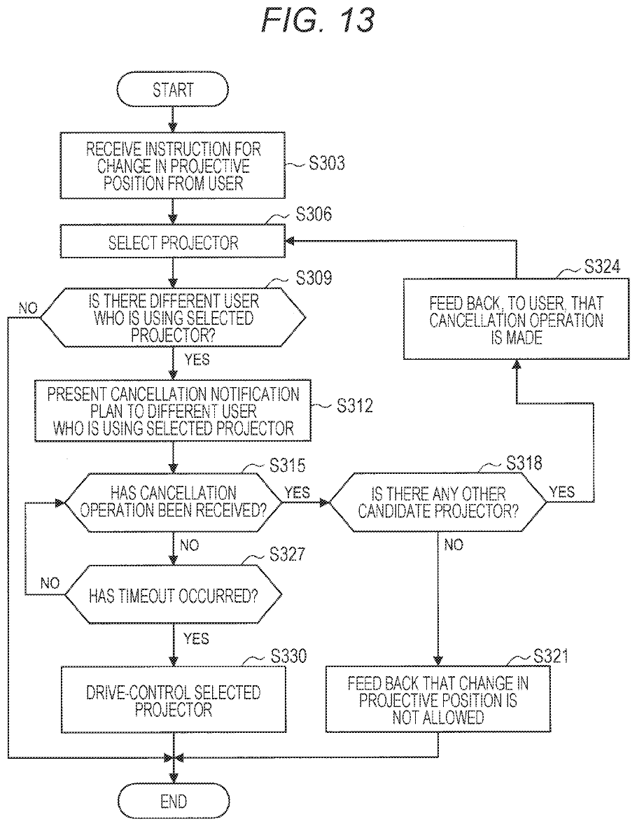

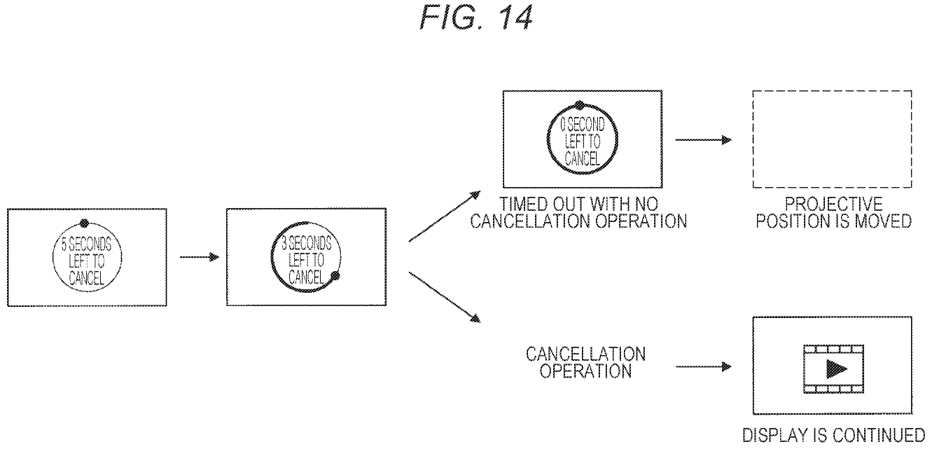

Next, a third embodiment will be described with reference to FIGS. 13 and 14. According to the present embodiment, the first user having already used the drive projector 300 is given authority such that a change in projective position corresponding to an instruction for projection from the second user can be arbitrarily canceled, so that the first user can prevent an unintended movement of the display.

Moreover, the information processing device 100 may determine whether or not to issue notification for cancellation operation to the first user in accordance with the condition of the first user, so that, in a case where no cancellation is required, no notification for cancellation operation is issued. This arrangement enables prompt drive control of the drive projector 300 corresponding to the instruction from the second user, resulting in no occurrence of standby time for cancellation operation. For example, in a case where a person who issues an instruction for projection later is identical to a person who has already issued an instruction for projection, the information processing device 100 immediately drives the drive projector 300 without issuing notification for cancellation operation. Moreover, on condition that a person having already issued an instruction for projection does not use the drive projector 300 any longer, such as not viewing the projective image, not doing any operation, or not being nearby, the information processing device 100 immediately drives the drive projector 300 without issuing notification for cancellation operation.

(Operation Processing)

FIG. 13 illustrates an exemplary flow of cancellation operation processing according to the present embodiment. As illustrated in FIG. 13, first, the information processing device 100 receives an instruction for change in projective position from a user (step S303), and then selects a projector (step S306). It is assumed that an instruction for change in projective position is issued by an uttered voice, such as “Display here”, “[agent name]!”, or “Show me a calendar”, a predetermined gesture, or an operation input from an input device, such as a pointing device, as described above. Moreover, the information processing device 100 selects a projector that can perform projection at the position instructed by the user (e.g., a projector having a favorable angle of view, favorable luminance, and the like). In a case where a plurality of drive projectors 300 is provided, the information processing device 100 selects one projector that can perform projection at the position instructed by the user.

Next, the information processing device 100 determines whether or not any different user who is using the selected projector is present (step S309). Specifically, the information processing device 100 determines whether or not any user who is viewing an image projected by the selected projector is present (the orientation of the face or the direction of line-of-sight toward the image), for example, on the basis of a captured image captured by the camera in the sensor 320. Moreover, the information processing device 100 may determine whether or not the selected projector is in use, for example, on the basis of whether or not any user is present near the image projected by the selected projector or whether or not a certain time or more has elapsed since the most recent operation.

Next, in a case where a different user (current user) who is using the selected projector is present (step S309/Yes), the information processing device 100 performs control to present a cancellation notification screen to the different user who is using the selected projector (step S312). For example, the information processing device 100 causes the drive projector 300 to display the cancellation notification screen at the projective position that the different user is currently viewing. For example, in a case where the different user is viewing a film content projected by the drive projector 300, the information processing device 100 may temporarily stop the film content and display the cancellation notification screen on the screen of the film content. Here, FIG. 14 illustrates an exemplary cancellation notification screen according to the present embodiment. As illustrated in FIG. 14, for example, the cancellation notification screen may indicate countdown until cancellation reception finishes. In response to this, the different user who is using the drive projector 300 performs a cancellation operation (operation of issuing an instruction for interrupt cancellation) by utterance of a predetermined keyword (e.g., “Cancel!”), or by gesture (e.g., hit a desk or tap the cancellation notification screen).

Next, the information processing device 100 waits for reception of a cancellation operation until a predetermined time elapses (until timeout) (step S327).

Next, in a case where a cancellation operation is received from the different user (step S315/Yes), the information processing device 100 is not allowed to use the selected projector, and thus selects another candidate projector (that can perform projection) (step S318).

Next, in a case where no different projector is available (step S318/No), the information processing device 100 feeds back, to the user, that change is not allowed in projective position (step S321). If a projector display region is located at any position in the view of the user, feedback may be performed visually, otherwise feedback may be performed acoustically. Moreover, in a case where the user keeps holding an input device, such as a pointing device, feedback may be performed through the input device (e.g., sound, vibration, or light).

Meanwhile, in a case where a different projector is available (step S318/Yes), the information processing device 100 feeds back, to the user (who has issued the instruction for change in projective position), that a cancellation operation is made (by the current user) (step S324), and additionally selects the different projector (step S306). Then, the information processing device 100 repeats the processing in steps S309 to S318.

As above, in a case where a cancellation operation is performed, a different projector that can perform projection is searched for. Thus, in a case where a plurality of projectors is provided, a proper projector can be selected along intensions of a plurality of users. The user does not need to issue an explicit instruction which projector is to be used, so that time and labor in operation can be reduced.

Moreover, in a case where a timeout occurs with no cancellation operation from the current user (step S327/Yes), the information processing device 100 performs control such that the selected projector is driven in accordance with the instruction for change in projective position from the user (step S330).

Note that, herein, exemplarily, the absence of cancellation is determined on the basis of timeout, but the present embodiment is not limited to this. Thus, for example, display of two options of Yes/No on the cancellation notification screen may prompt a user to make a selection. Moreover, the configuration of the cancellation notification screen illustrated in FIG. 14 is exemplary. The present embodiment is not limited to this, and thus other expression may be provided.

### 3-4. Fourth Embodiment (Feedback)

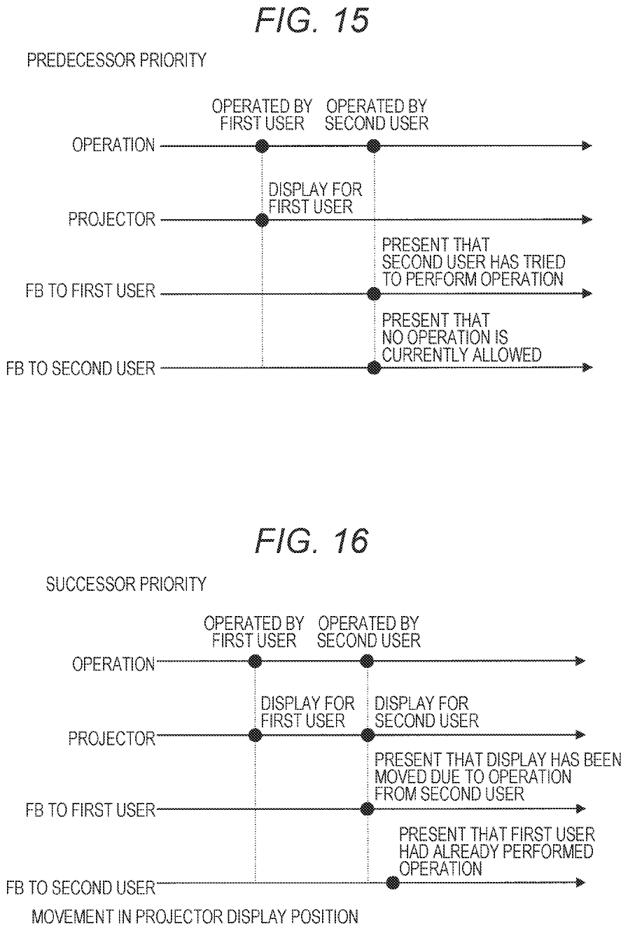

Next, a fourth embodiment will be described. According to the present embodiment, in a case where the second user issues an instruction for change in projective position while the first user is using the drive projector 300, in accordance with which of the first user and the second user is prioritized, the users are appropriately notified (given a feedback) of the respective conditions thereof. This arrangement enables a more comfortable operation to a projector under an environment with a plurality of persons. Specific description will be given below with reference to FIGS. 15 to 17.

(Predecessor Priority)

FIG. 15 is an explanatory sequence diagram of feedback at the time of predecessor priority. FIG. 15 illustrates the timings of the presence or absence of operation, control of a projector, feedback (FB) to the first user (predecessor), and FB to the second user (successor), on a time-series basis.

In the present specification, the term “predecessor priority” means that a person who has already operated (used) a projector is preferentially allowed to use the projector. With the predecessor priority set, for a certain time after a user starts using the drive projector 300 (e.g., viewing/listening to a film content), the information processing device 100 enables the user (predecessor) to preferentially use the drive projector 300. Therefore, even in a case where a different user (successor) performs an operation input later (e.g., an instruction for change in projection, such as “Display a calendar here” or “Show here”), the operation is made ineffective. In this case, the successor may be confused because the successor does not know why the operation is ineffective. Thus, as illustrated in FIG. 15, the information processing device 100 feeds back, to the user who has performed the later operation (successor, namely, the second user), that no operation is currently allowed. If a different projector that can project a picture in the field of view of the second user is present, the feedback to the second user may be performed visually, otherwise the feedback to the second user may be performed acoustically. Moreover, in a case where the second user uses an input device, such as a pointing device, for example, vibratory, optical, or acoustic feedback may be performed through the input device.

Moreover, as illustrated in FIG. 15, the effect that the different user has performed an operation may be fed back to the predecessor (first user). For example, because the first user has a projector allocated thereto, through the projector, feedback may be performed with a picture or feedback may be performed acoustically.

As above, the first and second users are notified of the respective conditions thereof, so that communication can be established between the first and second users, resulting in achievement of projector operation through inter-user dialogue. For example, the predecessor can drop or transfer the right of operation, and can pass the right of operation to the successor, for example, by a predetermined voice utterance, a gesture, a touch operation to UI, or a button operation to an input device.

(Successor Priority)

FIG. 16 is an explanatory sequence diagram of feedback at the time of successor priority. FIG. 16 illustrates the timings of the presence or absence of operation, control of a projector, FB to the first user (predecessor), and FB to the second user (successor), on a time-series basis.

In the present specification, the term “successor priority” means that, even in a case where a person who has already operated (used) a projector is present, a person who performs an operation later is preferentially allowed to use the projector (can acquire the right of operation). With the successor priority set, in a case where, even with a user who is using the drive projector 300, a different user issues an instruction for change in projective destination later, the information processing device 100 controls, for example, the drive of the drive projector 300 such that a change is made in projective destination in accordance with the instruction. Note that, according to the first and second embodiments, in a case where no projective position visible to both users is present, the drive projector 300 is driven in accordance with the instruction for change in projective destination from the successor. Thus, it can be said that the successor priority is adopted in part of the processing.

As illustrated in FIG. 16, in a case where an operation is received from the second user who is the successor, the information processing device 100 drives the projector in accordance with the operation from the second user, to present an image to the second user. In this case, the information processing device 100 notifies the first user by who the second user has taken over the projector already used, that movement is made in display due to the operation from the second user. The notification may be presented to the first user by the projector before the movement in display.

Meanwhile, the second user may be notified that the first user has already operated (used) the projector. The notification to the second user may be presented by the projector after the movement in display.

(Sharing Priority)

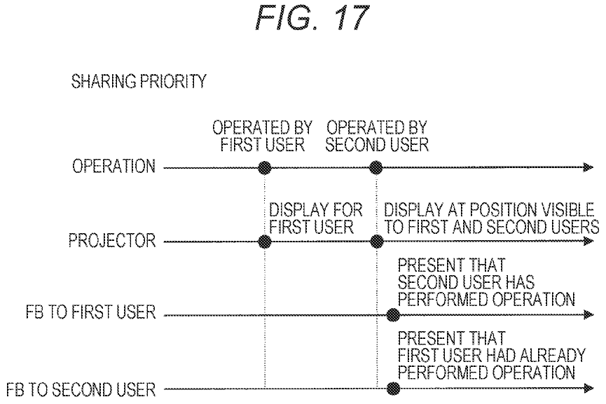

FIG. 17 is an explanatory sequence diagram of feedback at the time of sharing priority. FIG. 17 illustrates the timings of the presence or absence of operation, control of a projector, feedback (FB) to the first user (predecessor), and FB to the second user (successor), on a time-series basis.

In the present specification, the term “sharing priority” means that, as described in the first and second embodiments, on condition that a person who has already operated (used) a projector is present, in a case where a person who operates the projector later appears, an image is projected at a place visible to both users with the projector shared between both users.

As illustrated in FIG. 17, in a case where an operation is received from the second user while a projector is performing display in accordance with an operation from the first user, the information processing device 100 drive-controls the projector such that display is performed at a position visible to the first and second users. In this case, the information processing device 100 notifies the first user that the second user has performed an operation, and notifies the second user that the first user has already operated (used) the projector. The notifications both can be presented by the projector, for example, after movement in display.

### 3-5. Fifth Embodiment (Priority Rule Setting)

Next, a fifth embodiment will be described. According to the fourth embodiment, the predecessor priority, the successor priority, and the sharing priority each have been described. According to the present embodiment, a determination may be made in advance such that at least any of the priority rules is applied, or at least any of the priority rules may be appropriately determined in accordance with conditions. For example, the information processing device 100 appropriately sets a proper priority rule in accordance with the content that the predecessor is viewing (content that the projector is projecting) or the content requested by the successor (call for a new screen). More specifically, for example, the successor priority is set, normally. In a case where a content, such as a film, is being presented to the predecessor (content to which easily taking over the right of operation by a different user is unfavorable), the predecessor priority is set.

(Operation Processing)

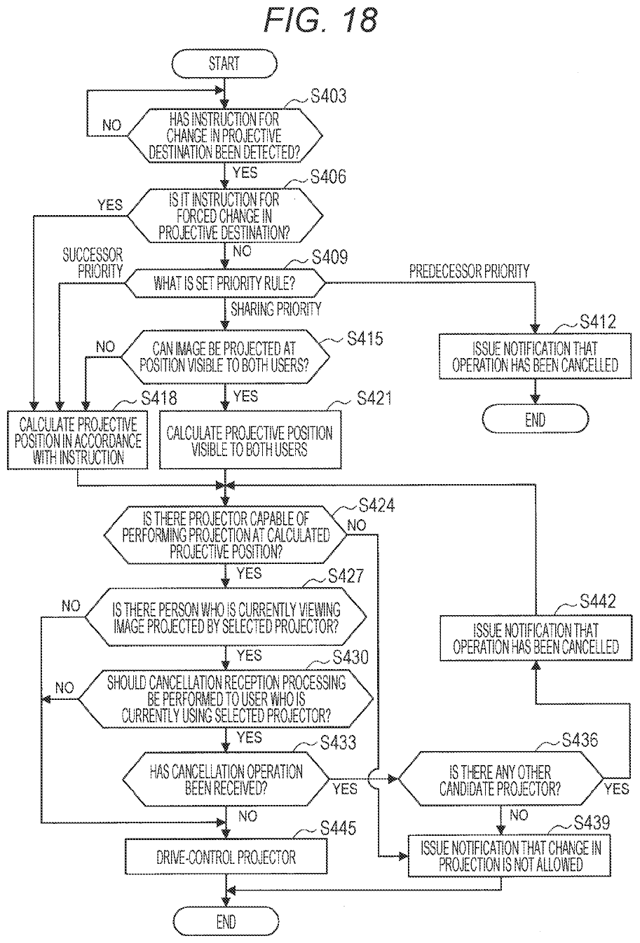

Such operation processing according to the present embodiment will be specifically described with reference to FIG. 18. FIG. 18 is a flowchart of an exemplary flow of drive control processing according to the present embodiment.

As illustrated in FIG. 18, first, in a case where an instruction for change in projective destination is detected (step S403/Yes), the information processing device 100 determines whether or not the instruction for change in projective destination is forcible (step S406). Forcible change in projective destination can be made, for example, by utterance of a predetermined keyword (magic word), particular gesture, or use of a button and the like of an input device, and indicates an exceptional operation of forcibly moving a projector toward a designated position.

Next, in a case where the instruction for change in projective destination is not forcible (step S406/No), the information processing device 100 sets a priority rule (step S409). For example, in a case where, to a user who has already used the projector, a content to which easy taking over by a different user is unfavorable is being presented, such as film viewing/listening, the information processing device 100 sets the “predecessor priority”. In a case where a content different from the above content is being presented, the information processing device 100 sets the “successor priority” or the “sharing priority”. The “sharing priority” may be set, for example, in a case where an instruction for projection from the successor is only for change in position and is not for a call for a new screen (switching to another screen). Alternatively, the “sharing priority” may be set in a case where a projective position visible to both users is highly likely to be present, such as a case where both users are located relatively close. Moreover, the information processing device 100 may set the “successor priority” in a case where the “predecessor priority” or the “sharing priority” is not proper. Moreover, in a case where the number of persons who use a projector can be estimated to be one, such as a case where only one person is present in the room, the information processing device 100 may set the “successor priority” (prompt drive is favorable because the person who is the predecessor issues an instruction).

Next, in a case where the “predecessor priority” is set (step S409/predecessor priority), the information processing device 100 notifies the successor that the operation has been cancelled (feedback) and then the processing finishes (step S412).

Moreover, in a case where the “sharing priority” is set (step S409/sharing priority), the information processing device 100 determines whether or not projection can be performed at a position visible to both users (step S415).

Moreover, in a case where the “successor priority” is set (step S409/successor priority) or in a case where, with the “sharing priority” set, it is determined that projection cannot be performed at a position visible to both users (step S415/No), the information processing device 100 calculates a projective position in accordance with the instruction from the successor (step S418). Note that, in a case where the instruction for change in projective destination is forcible (step S406/Yes), similarly, the information processing device 100 calculates a projective position in accordance with the instruction from the successor.

Meanwhile, in a case where, with the “sharing priority” set, it is determined that projection can be performed at a position visible to both users (step S415/Yes), the information processing device 100 calculates a projective position visible to both users (step S421).

Next, the information processing device 100 determines whether or not any projector that can perform projection at the calculated projective position is present (step S424).

Next, in a case where a projector that can perform projection at the calculated projective position is present (step S424/Yes), the information processing device 100 determines whether or not any person who is currently viewing the projective image by the selected projector is present (namely, a person who is using the selected projector) (step S427). Processing of determining whether or not any user who is using the selected projector is present, is similar to the processing of determination in step S309 of FIG. 13.

Next, in a case where a person who is currently viewing the projective image by the selected projector is present (step S427/Yes), the information processing device 100 determines whether or not to perform cancellation reception processing to the user who is currently using the selected projector (step S430). The cancellation operation processing is similar in content to that described with reference to the third embodiment. The information processing device 100 determines whether or not to give the predecessor a time for cancelling movement in display based on the operation from the successor. The information processing device 100 determines whether or not to perform the cancellation reception processing, for example, in accordance with conditions. Specifically, for example, in a case where it can be assumed that a talk of some kind regarding change in projection has already been made between the users, such as a case where the users are adjacent to each other or a case where the distance between the users is short, in a case where an agreement on change in projection already made between the users has been grasped by voice recognition of conversation between the users, or in a case where the predecessor is a predetermined ineligible person, such as a child, for example, the information processing device 100 may determine not to perform the cancellation reception processing, otherwise, the information processing device 100 may determine to perform the cancellation reception processing.

Moreover, in a case where a person is operating a plurality of projectors alone, such as a case where only one person is present in the room, the information processing device 100 may determine not to perform the cancellation reception processing. In a case where a user uses (gazes at) a plurality of projectors all, for selection of a proper projector (projector projecting a content of which the user does not care about cancellation of the use), the cancellation reception processing may be performed.

Next, the cancellation reception processing is determined to be performed (step S430/Yes) and a cancellation notification screen is presented to the predecessor (refer to FIG. 14). In a case where a cancellation operation is performed (step S433/Yes), the information processing device 100 searches for any other candidate projector (step S436).

Then, in a case where no other candidate projector is present (step S436/No) or in a case where no projector that can perform projection at the calculated projective position is present in step S424 (step S424/No), the successor is notified that change is not allowed in projection (step S439).

Meanwhile, in a case where any other candidate projector is present (step S436/Yes), the information processing device 100 notifies the successor that the operation has been cancelled (step S442), and additionally selects the different projector. Then, the information processing device 100 repeats the processing from step S424.

Moreover, in a case where no cancellation operation is received (namely, no cancellation operation is performed by the predecessor) (step S433/No), in a case where no person who is currently viewing the projective image by the selected projector is present in step S427 (step S427/No), or in a case where the cancellation reception processing is determined not to be performed in step S430 (step S430/No), the information processing device 100 performs control such that the projector is driven toward the projective position calculated in step S418 or S421 (step S445).

### 4. APPLICATIONS

According to the embodiment described above, the image display with the drive projector 300 has been described. However, the present embodiment is not limited to this, and thus may be applied to, for example, image display with another display device, such as an eyewear-type see-through HMD. For example, on condition that a plurality of persons wearing respective eyewear-type see-through HMDs, is sharing an AR content superimposition-displayed in the real space, in a case where an instruction for change in the display position of the AR content is issued, the present embodiment can be applied. Specifically, for example, in a case where an instruction for change in the display position of the AR content is issued, the AR content may be moved to a position visible to the first user who has already used the AR content (e.g., operated and viewed/listened to) and the second user having issued the instruction for change (e.g., a position favorable to a plurality of persons, such as a position between the two). Moreover, for example, a movable display-equipped robot is assumed as another display device. Specifically, for example, in a case where an instruction for change in the position of a display-equipped robot is issued, the robot may be moved to a position visible to the first user who has already used the robot (e.g., operated and viewed/listened to) and the second user having issued the instruction for change (e.g., a position favorable to a plurality of persons, such as a position between the two).

Moreover, the present embodiment enables a speaker or sound-source localization position to be moved in accordance with movement in the display position. The speaker may be provided at the drive projector 300 or may be separated from the drive projector 300. Moreover, the speaker may be an ultrasonic speaker capable of localizing sound. At the time of movement in the display position to a position favorable to a plurality of persons, sound can be localized at the position favorable to the plurality of persons.

Moreover, according to the embodiment, a projective position is determined in accordance with, for example, the position of a user. However, the present embodiment is not limited to this. For example, with a plurality of projective positions previously determined by presetting, a projective position may be selected from the plurality of projective positions previously prepared, in accordance with, for example, the position of a user. Moreover, in a case where there is a projective position that a user often uses, such a projective position that is often used may be determined in accordance with the position of the user. For example, in a case where, with a user sitting on a sofa, the position above the television is often determined as a projective position, an instruction for projection, such as “Show me a calendar”, issued by the user sitting on the sofa, causes the information processing device 100 to determine the position above the television as a projective position.

Moreover, instead of causing display of a picture at a position favorable to a plurality of persons, the information processing device 100 may prompt a user to move such that a picture is displayed at a position favorable to a plurality of persons. In this case, the information processing device 100 may cause one person to move. Alternatively, the information processing device 100 may cause display at a place that a plurality of persons can view easily (e.g., a place possibly enabling a large angle of view), such as a dining table, to prompt the persons in the room to move to the dining table.

Moreover, in a case where the projective position instructed by a person who has performed a later operation or a position visible to a plurality of persons is unsuitable for projection (e.g., a place unfavorable for the environment of projection, such as a too bright place, a place not flat, or a place having access for persons, such as a door), the information processing device 100 may perform display such that such a place is avoided.

Moreover, in a case where split display is performed, the information processing device 100 may make a change in split ratio in accordance with a content. For example, only for a call for an agent, the original content may be displayed larger and an image of the agent may be displayed smaller in a corner.

Moreover, in a case where a picture cannot be displayed at a position favorable to a plurality of persons or in a case where a display device different from the projector is available to a person who has issued a later instruction, the information processing device 100 may cause the display device different from the projector to display a picture. In a case where, for example, a television, a smartphone, or the like is present near a person who has issued a later instruction for change in projective position, such a display device may display a content (in this case, no change is made in the projective position of the original content).

Moreover, while split display is being performed at a position favorable to a plurality of persons, when one of the plurality of persons leaves, the information processing device 100 may release the split to increase the ratio of a content favorable to the remaining persons.

Moreover, if an agreement is made between users, switching among a split screen, full screen, etc. may be performed.

Moreover, weighting may be previously performed between users. For example, for a parent and a child, a larger weight is assigned to the parent. Thus, in a case where an adult and a child are present, a picture can be projected at a position closer to the adult or the split ratio of a content that the adult is viewing can be increased at the time of split display. Moreover, a weight of 0 may be assigned to persons ineligible for an operator for a projector, such as a younger child and a guest, such that the positions thereof and operations therefrom do not affect the system.

Moreover, an instruction for a projective position may be issued with a hand-touchable object (real object). For example, in a case where a user places a predetermined object on a table, display (projection) may be performed on the table (furthermore, near the object). In a case where the user hands a different person the object and the different person places the object at a different place, display may be performed at the place at which the object is placed.

Moreover, even in a case where a different content is displayed at the moved projective place, returning the original display position may cause display of the original content.

Moreover, processing may be appropriately changed in accordance with the attribute of an operator. For example, in a case where an elderly person is a user, the standby time for cancellation (countdown) may be lengthened.

Moreover, processing may be appropriately changed in accordance with the state of an operator. For example, in a case where the line-of-sight of a user deviates from the projective image (e.g., a case where the user's eyes are turned away for a moment), the standby time for cancellation may be lengthened. Moreover, in a case where a user is familiar with operation, the standby time for cancellation may be shortened.

Moreover, the predecessor priority rule may be applied to a content different from films. For example, at the time of input of text, such as input of a password or creation of a message, or at the time of a call, the predecessor priority rule may be applied.

Moreover, in a case where an operation of prohibiting movement of the display image is explicitly performed, the predecessor priority rule may be applied.

Moreover, processing may be appropriately changed in accordance with a time period. For example, at night, the right of operation may be arranged not to be given to children or an adult priority rule may be applied such that an operation from an adult is prioritized.

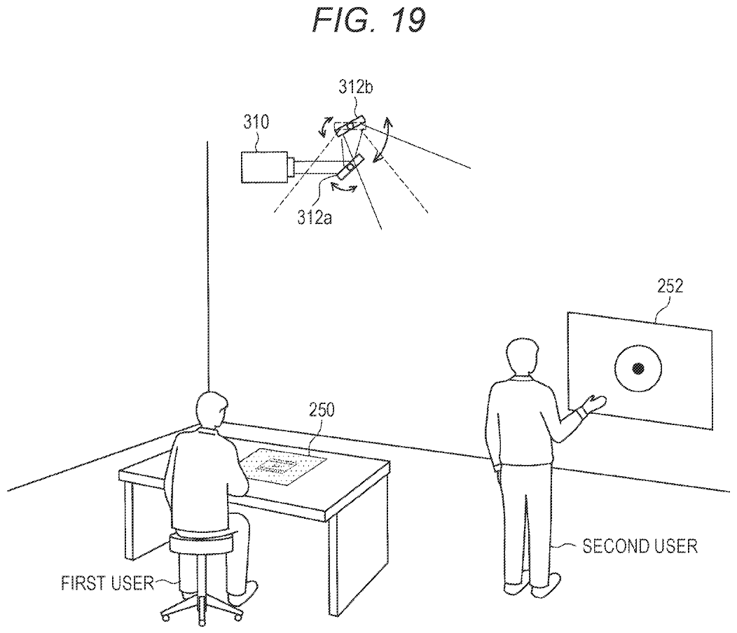

Moreover, in a case where the projector according to the present embodiment can perform simultaneous projection at a plurality of places by a time-division technique with drive mirrors (Galvanometer mirrors), changing the duty cycle between the screen before movement and the screen after movement makes it possible to change the priority in display contents. FIG. 19 is an explanatory view of use of a projector that projects pictures simultaneously at a plurality of places by a time-division technique with drive mirrors. As illustrated in FIG. 19, for example, driving drive mirrors 312a and 312b at high speed and additionally switching displayed pictures enable projection of different pictures at a plurality of places, such as the upper face of a table and a wall. In this case, for example, in a case where an instruction for change in projective position (display at the wall) is issued by the second user while an image 250 is being displayed for the first user, the information processing device 100 may perform control such that the brightness of the image 250 decreases gradually and additionally the brightness of an image 252 for use in display for the second user increases gradually (control in brightness can be adjusted, for example, by time-division allocation). Moreover, during the standby time for a cancellation operation from the first user after causing display of a cancellation notification screen on the image 250, the information processing device 100 keeps the image 252 displayed lightly to the second user. Thus, feedback of the operation can be presented to the second user during the standby time (operation for change in projective position has been properly recognized on the system side).

Moreover, according to the embodiment, regarding cancellation operation, a cancellation notification screen is displayed. However, the present embodiment is not limited to this. For example, at the time of an instruction for change in projection from the second user, with the display image having transitioned to the destination in movement, the first user who has already performed an operation may be notified of the countdown to cancellation operation by sound. For example, with a directional speaker, a voice of cancellation notification may be brought into sound-source localization at the display position before movement. In a case where a cancellation operation is performed, for example, by voice or gesture, the information processing device 100 controls the projector such that the display image returns to the original position.

### 5. SUMMARY

As described above, the information processing system according to the embodiment of the present disclosure, enables display control to be performed more properly in response to an instruction for display from a user in a display system that a plurality of persons uses.

The preferred embodiments of the present disclosure have been described in detail above with reference to the accompanying drawings, but the present technology is not limited to the embodiments. It is obvious that a person skilled in the technical field of the present disclosure conceives various types of alterations or modifications in the scope of the technical idea described in the claims, and thus it is understood that these rightfully belong to the technical scope of the present disclosure.

For example, a computer program for achievement of the function of the information processing device 100 or the drive projector 300 can be created in the hardware, such as the CPU, the ROM, and the RAM, built in the information processing device 100 or the drive projector 300. Moreover, provided is a computer-readable storage medium storing the computer program.

Moreover, the effects described in the present specification are just explanatory or exemplary, and thus are not limitative. That is the technology according to the present disclosure has other effects obvious to a person skilled in the art, from the descriptions in the present specification, in addition to the effects or instead of the effects.

Note that the present technology can have the following configurations.

(1)

An information processing device including:

a control unit configured to determine, when an instruction for display from a user is detected, display control corresponding to the instruction for display from the user in accordance with a position of the user and a current display condition having already been given to a different user.

(2)

The information processing device according to (1) above, in which the current display condition includes a display position or a display content.

(3)

The information processing device according to (1) or (2) above, in which

the control unit performs control, in a case where the instruction for display from the user is for movement of a display position in the current display condition, such that the display position is moved to a visible region to the user and the different user.

(4)

The information processing device according to (3) above, in which

the control unit determines the visible region, on the basis of the position of the user and a position of the different user.

(5)

The information processing device according to (4) above, in which

the control unit further determines the visible region, in consideration of an orientation of the user and an orientation of the different user.

(6)

The information processing device according to (3) above, in which

the control unit determines the visible region, on the basis of an overlap between a range of visibility of the user and a range of visibility of the different user.

(7)

The information processing device according to (2) above, in which

the control unit performs control such that the display position is moved between the display position in the current display condition and a display position corresponding to the instruction for display from the user.

(8)

The information processing device according to any one of claims 2) to (7) above, in which

the control unit performs control, in a case where the instruction for display from the user is for change in the display content in the current display condition, such that the display position is moved to a visible region to the user and the different user and additionally a split screen including the display content in the current display condition and a display content corresponding to the instruction for display from the user is displayed.

(9)

The information processing device according to any one of (2) to (8) above, in which

the control unit performs control, in a case where no visible region to the user and the different user is present, such that the display position is moved to a display position corresponding to the instruction for display from the user and additionally a display content corresponding to the instruction for display from the user is displayed.

(10)

The information processing device according to any one of (3) to (9) above, in which

the control unit performs, after changing the display position and a display content in accordance with the instruction for display from the user, processing of restoring the display position and the display content with predetermined timing.

(11)

The information processing device according to any one of (1) to (10) above, in which

the control unit issues, when changing a display position in accordance with the instruction for display from the user, notification for cancellation operation to the different user.

(12)

The information processing device according to (11) above, in which

the control unit cancels the change of the display position when the cancellation operation is performed by the different user.

(13)

The information processing device according to (12) above, in which

the control unit searches for, after canceling the change of the display position, another display device corresponding to the instruction for display from the user.

(14)

The information processing device according to any one of (1) to (13) above, in which

the control unit notifies, after moving a display position in accordance with the instruction for display from the user, the different user of a movement of display.

(15)

The information processing device according to any one of (1) to (13) above, in which

the control unit notifies the user, in a case where display is continued with priority to the different user in response to the instruction for display from the user, that no operation is allowed to be received.

(16)

The information processing device according to any one of (1) to (15) above, in which

the control unit sets, in accordance with the current display condition, at least any of:

display control of prioritizing the user having issued a later instruction;

display control of prioritizing the different user having already been viewing and listening; and

display control of prioritizing sharing between the user and the different user.

(17)

The information processing device according to (16) above, in which

the control unit performs the setting in accordance with a content classification of a display content in the current display condition.

(18)

The information processing device according to any one of (1) to (17) above, in which

the control unit performs display control with a drive projector.

(19)

An information processing method to be performed by a processor, the information processing method including:

determining, when an instruction for display from a user is detected, display control corresponding to the instruction for display from the user in accordance with a position of the user and a current display condition having already been given to a different user.

(20)

A recording medium storing a program for causing a computer to function as a control unit that determines, when an instruction for display from a user is detected, display control corresponding to the instruction for display from the user in accordance with a position of the user and a current display condition having already been given to a different user.

(21)

An information processing device including:

a control unit configured to issue, when an instruction for display from a user is detected, notification for cancellation operation to a different user who is viewing and listening to a display having already been presented.

(22)

The information processing device according to (21) above, in which

the control unit moves, in a case where the different user is not gazing at the display or in a case where the different user is not near the display, a display position in accordance with the instruction for display from the user, without issuing the notification for cancellation operation.

(23)

The information processing device according to (21) above, in which

the control unit moves, in a case where the cancellation operation is not performed by the different user, a display position in accordance with the instruction for display from the user.

(24)

The information processing device according to (21) above, in which

the control unit continues, in a case where the cancellation operation is performed by the different user, display presentation to the different user and additionally notifies the user that no operation is allowed to be received.

### REFERENCE SIGNS LIST

1 Information processing system
100 Information processing device
110 I/F unit
120 Control unit
121 Three-dimensional space recognition unit
122 Projective-position calculation unit
123 Projector control unit
130 Spatial information storage unit
140 Content storage unit
300 Drive projector
310 Projector
320 Sensor
330 Drive mechanism
340 Speaker

1. An information processing device comprising:
a control unit configured to determine, when an instruction for display from a user is detected, display control corresponding to the instruction for display from the user in accordance with a position of the user and a current display condition having already been given to a different user.

2. The information processing device according to claim 1, wherein the current display condition includes a display position or a display content.

3. The information processing device according to claim 1, wherein
the control unit performs control, in a case where the instruction for display from the user is for movement of a display position in the current display condition, such that the display position is moved to a visible region to the user and the different user.

4. The information processing device according to claim 3, wherein
the control unit determines the visible region, on a basis of the position of the user and a position of the different user.

5. The information processing device according to claim 4, wherein
the control unit further determines the visible region, in consideration of an orientation of the user and an orientation of the different user.

6. The information processing device according to claim 3, wherein
the control unit determines the visible region, on a basis of an overlap between a range of visibility of the user and a range of visibility of the different user.

7. The information processing device according to claim 2, wherein
the control unit performs control such that the display position is moved between the display position in the current display condition and a display position corresponding to the instruction for display from the user.

8. The information processing device according to claim 2, wherein
the control unit performs control, in a case where the instruction for display from the user is for change in the display content in the current display condition, such that the display position is moved to a visible region to the user and the different user and additionally a split screen including the display content in the current display condition and a display content corresponding to the instruction for display from the user is displayed.

9. The information processing device according to claim 2, wherein
the control unit performs control, in a case where no visible region to the user and the different user is present, such that the display position is moved to a display position corresponding to the instruction for display from the user and additionally a display content corresponding to the instruction for display from the user is displayed.

10. The information processing device according to claim 3, wherein
the control unit performs, after changing the display position and a display content in accordance with the instruction for display from the user, processing of restoring the display position and the display content with predetermined timing.

11. The information processing device according to claim 1, wherein
the control unit issues notification for cancellation operation to the different user when changing a display position in accordance with the instruction for display from the user.

12. The information processing device according to claim 11, wherein
the control unit cancels the change of the display position when the cancellation operation is performed by the different user.

13. The information processing device according to claim 12, wherein
the control unit searches for, after canceling the change of the display position, another display device corresponding to the instruction for display from the user.

14. The information processing device according to claim 1, wherein
the control unit notifies, after moving a display position in accordance with the instruction for display from the user, the different user of a movement of display.

15. The information processing device according to claim 1, wherein
the control unit notifies the user, in a case where display is continued with priority to the different user in response to the instruction for display from the user, that no operation is allowed to be received.

16. The information processing device according to claim 1, wherein
the control unit sets, in accordance with the current display condition, at least any of:
display control of prioritizing the user having issued a later instruction;
display control of prioritizing the different user having already been viewing and listening; and
display control of prioritizing sharing between the user and the different user.

17. The information processing device according to claim 16, wherein
the control unit performs the setting in accordance with a content classification of a display content in the current display condition.

18. The information processing device according to claim 1, wherein
the control unit performs display control with a drive projector.

19. An information processing method to be performed by a processor, the information processing method comprising:
determining, when an instruction for display from a user is detected, display control corresponding to the instruction for display from the user in accordance with a position of the user and a current display condition having already been given to a different user.

20. A recording medium storing a program for causing a computer to function as a control unit that determines, when an instruction for display from a user is detected, display control corresponding to the instruction for display from the user in accordance with a position of the user and a current display condition having already been given to a different user.
